(19) United States
(12) Patent Application Publication
(10) Pub. No.: US 2016/0086339 A1
(43) Pub. Date: Mar. 24, 2016

(54) METHOD OF PROVIDING CARTOGRAIC INFORMATION OF AN ELETRICAL COMPONENT IN A POWER NETWORK

(71) Applicant: ABB Technology AG, Zurich (CH)

(72) Inventors: Olivier STEIGER, Zurich (CH); Christopher GANZ, Zurich (CH); Yannick MARET, Dattwil (CH); Aldo DAGNINO, Cary, NC (US)

(73) Assignee: ABB TECHNOLOGY AG, Zurich (CH)

(21) Appl. No.: 14/491,119

(22) Filed: Sep. 19, 2014

(51) Int. Cl. G06T 7/00; H04N 13/02; G06T 1/00; G01C 11/04

(52) U.S. Cl. CPC G06T 7/0046; G01C 11/04; H04N 13/0246; G06T 1/0007; G06T 2207/10012; G06T 2207/10021; G06T 2207/10028; G06T 2207/30184; G06T 2207/30244; G06T 2207/20221

(57) ABSTRACT

A method is disclosed for providing cartographic information of an electrical component in a power network. The cartographic information may include geographic coordinates and a type of the electrical component. The method can include obtaining a visual representation of the electrical component, wherein the visual representation contains location information about where the visual representation was made; determining the geographic coordinates of the electrical component based on the location information of the visual representation; and identifying the type of the electrical component by matching the visual representation with the predefined models relating to available kind of electrical components.

### FIELD

The disclosure relates to the field of cartography of a power network, for example, to a method of providing cartographic information such as geographic coordinates and a type of the electrical component in a power network.

### BACKGROUND INFORMATION

Cartography of an electrical network is the act of building a map that specifies the location and kind/type of electrical components that are part of the network, such as power lines, poles, transformers, breakers, etc. While a map of a transmission network can be readily available, such information might be approximate or inexistent for distribution networks. The former are mostly built and maintained by a single company and comparatively collimated. The latter on the other hand grow more organically, may spread over different utilities and may become ramified. Network maps can be helpful tools for monitoring, maintenance planning and quick localization of outage causes. They are also used to identify redundant and obsolete components.

### SUMMARY

A method is disclosed for providing cartographic information of an electrical component in a power network, wherein the cartographic information includes geographic coordinates and a type of the electrical component, the method comprising: obtaining a visual representation of the electrical component the visual representation contains location information about where the visual representation was made; determining the geographic coordinates of the electrical component based on the location information of the visual representation; and identifying the type of the electrical component by matching the visual representation with predefined models relating to available kinds of electrical components.

### BRIEF DESCRIPTION OF THE DRAWINGS

The subject matter disclosed herein will be explained in more detail in the following text with reference to preferred exemplary embodiments which are illustrated in the attached drawings, in which:

FIG. 1 shows an exemplary picture obtained from a Google Map, where a power network including primary devices such as power lines and transformers are shown in the picture;

FIG. 2 shows an exemplary picture obtained from Google Street, where the power lines are shown in the picture; and

FIG. 3 schematically shows a camera and electrical component, where the component location in the camera coordinate system and the camera parameters are known from camera information, and the component location in world coordinates system including latitude and longitude is to be determined.

The reference symbols used in the drawings, and their primary meanings, are listed in summary form in the list of designations. In principle, identical parts are provided with the same reference symbols in the figures.

### DETAILED DESCRIPTION

For geographic cartography, manual mapping of electrical networks is a lengthy and expensive process. On the other hand, visual material of excellent quality and coverage can now be obtained from public sources such as Digital Globe, Google Maps/Street view. It can also be acquired at reasonable cost using, for example drones, cell phones or distributed cameras.

An automated cartography is disclosed using available image material, in order to save cost and execution time for mapping an electrical network manually.

According to an exemplary embodiment of the disclosure, a method for providing cartographic information of an electrical component in a power network is disclosed. The cartographic information can include geographic coordinates and a type of the electrical component. The method can include: obtaining a visual representation of the electrical component, wherein the visual representation includes location information about where the visual representation was made, determining the geographic coordinates of the electrical component based on the location information of the visual representation, and identifying the type of the electrical component by matching the visual representation with the predefined models relating to available kind of electrical components respectively.

In accordance with an exemplary embodiment, the method can include: providing a symbol indicative of the type of the electrical component into a map at a map location corresponding to the geographic coordinates of the electrical component.

In accordance with an exemplary embodiment, the photographic representation can be obtained by an extraction from available visual material relating to the electrical component, or by taking a picture or video with a camera.

The camera for capturing the photographic representation can be at a certain distance to the electric component. In other words, the location of the camera need not be the same as the absolute geographic location of the electric component. However, based on the location information of the camera, the geographic location of the electric component can be determined, as described in a later part of this disclosure. In some embodiments disclosed herein, the camera location can be adopted without further adjustment as the approximate geographical coordinates of the component.

In accordance with an exemplary embodiment, the location information of the visual representation can include GPS coordinates. The location information of the visual representation may also include orientation information provided by a compass or a gyroscope.

In accordance with an exemplary embodiment, the camera can be a 3D camera working according to, for example, the stereo or time-of-flight principle.

In accordance with an exemplary embodiment, the method can include: calculating the geographic coordinates by image processing of the visual representation. In other words, the geographic location of the component as given for example by GPS might be refined by means for performing image processing (e.g., an image processor approximately programmed). For instance, 3D vision, (e.g., stereo), allows one to map the location of an object in the image to real-world/geographic coordinates.

The disclosure differs from manual cartography in that, for example, disclosed embodiments can enable a quick cartography with less effort for electrical networks of which only incomplete or no maps exist. For example, a method according to the disclosure allows one to build accurate maps of electrical networks in a short time, for example, minutes to days, depending on the algorithmic complexity, computational efficiency, size of network and quality of source material. Moreover, the cost can be reduced since there is no need for cartographers.

The disclosure is concerned with, for example, using image processing/computer vision in order to automatically generate maps of an electrical network from images/video of that network. The resulting maps can specify at least the exact geographic location and kind/type of all electrical components that are part of the network. Possible components can include power lines, poles & towers, transformers, breakers, etc.

The desired images or video can either be acquired using, for example, dedicated cameras or from publicly available source material. The dedicated cameras may, for instance, be mounted on drones (see, e.g., http://www.thecyberhawk.com/inspections/utilities), or distributed along the network at strategic locations (e.g., using webcams). Another exemplary solution is to rely on utility customers to shoot images, for instance using their cellphones. The latter solution has been discussed in U.S. patent application Ser. No. 14/046,370, filed Oct. 4, 2013, the disclosure of which is hereby incorporated by reference in its entirety.

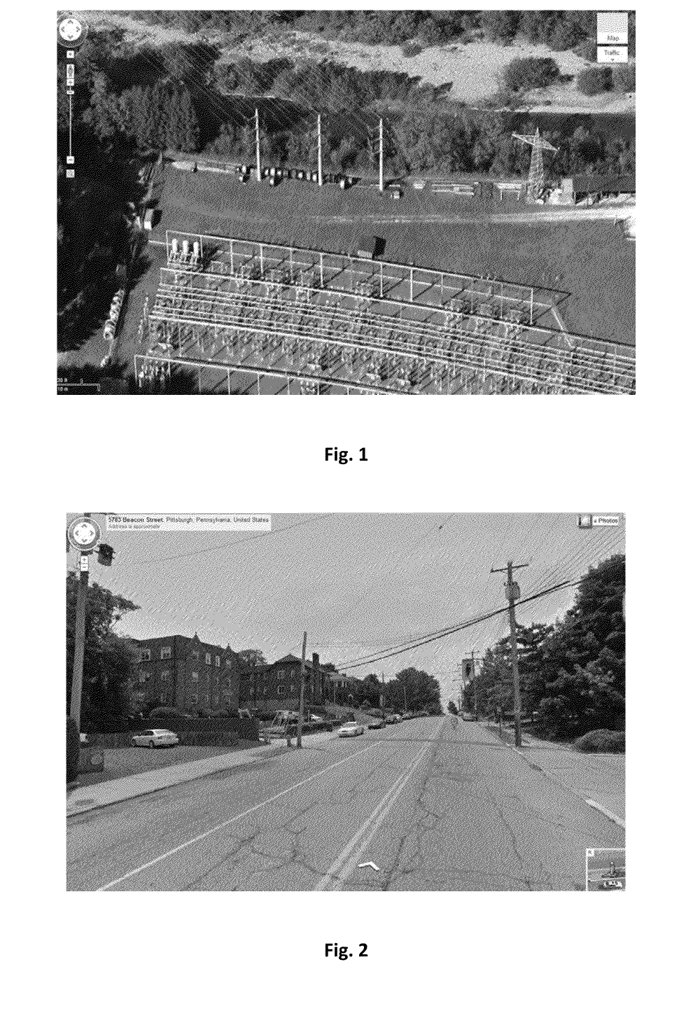

Instead of using dedicated cameras, it is also possible to extract the desired imagery from publicly available sources, such as Digital Globe, Google Maps and Google Street View. Such sources are increasingly of high quality and provide extensive geographical coverage. FIGS. 1 and 2 are exemplary pictures obtained from such available images (i.e., extracted from Google Maps and Google Street).

Once a suitable source material is obtained, the mapping operation can include the following stages: (i) locating and identifying the electrical components in the source material; and (ii) determining the absolute location (e.g., world coordinates) of the detected components. The absolute location can be given in form of geographic coordinates, such as, for example, latitude and longitude, optionally also with altitude as desired.

The localization and identification of electrical components is a computer vision task that is comparable with facial recognition, in terms of the difficulty and complexity. Note that the geographical area to be mapped can be analyzed exhaustively, for instance in a grid pattern. Alternatively, it is possible to track the electrical network (e.g., by following power lines) in order to reduce the amount of data to be analyzed.

The absolute location of the electric components that have been identified in stage (i) can be approximately determined using, for example, GPS information (e.g., from receivers mounted on the camera) or latitude/longitude coordinates produced by Google maps/Digital Globe. When more accurate location information is desired, this can, for example, be extracted from the images themselves. For example, detected components can be mapped from the 2D image plane to the world Euclidean coordinate system, which gives the absolute location of objects. This involves knowledge of intrinsic and extrinsic camera parameters obtained by, for example, calibration (e.g., a calibration device). Also, the task can be aided by additional depth information obtained via stereo vision or similar techniques for estimating the distance between camera and object. Note that unlike localization and identification of electrical components, the mapping from 2D images to world coordinates is a well-researched problem.

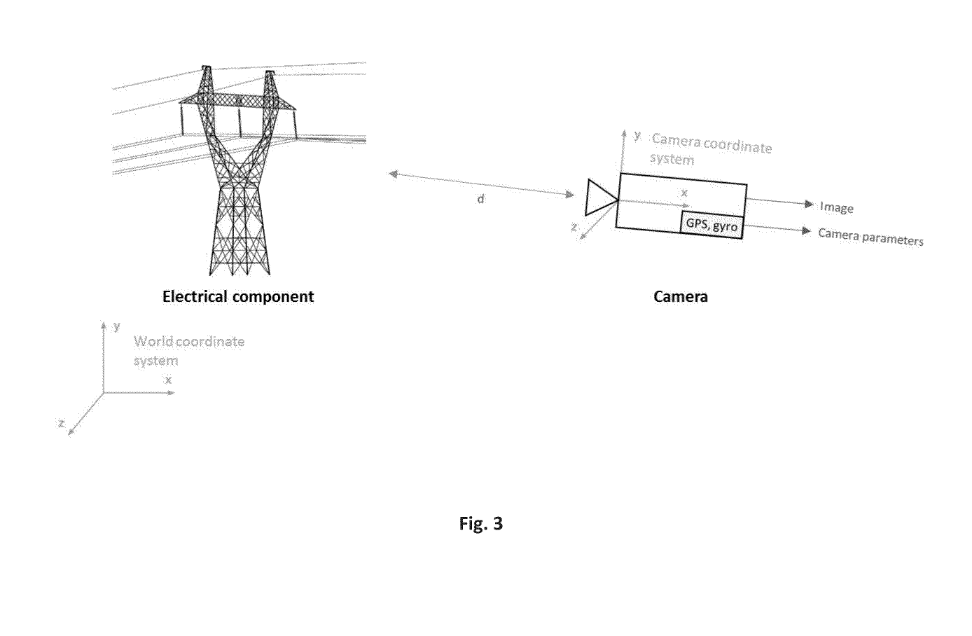

FIG. 3 shows an exemplary determination of the geographic coordinates of an electrical component based on camera parameters and object location in the image plane works as follows. The camera takes a picture of the electrical component. The picture may be a 3D picture. By means for image processing and object detection (e.g., an image processor), the location of the electrical component in the image (e.g., in the camera coordinate system), is determined. This includes the location of the component in the image plane (e.g., the y-z coordinates) as well as—with 3D cameras—the relative distance d between the object and the camera (e.g., the x coordinates).

Additionally, the intrinsic and extrinsic camera parameters can be determined by camera calibration (e.g., Sonka, Hlavac, Boyle, “Image Processing, Analysis, and Machine Vision”, Fourth Ed., 2014, Chap. 11), the disclosure of which is hereby incorporated by reference in its entirety, and from additional location information such as GPS coordinates and gyroscope data. The intrinsic parameters may encompass focal length, image format, principal point, and possibly non-linear parameters such as lens distortion. The extrinsic parameters denote the coordinate system transformations from 3D world coordinates to 2D/3D camera coordinates (e.g., position of the camera center and the camera's heading in world coordinates).

From the known electrical component's location in the camera coordinate system and camera parameters, it is then possible to compute the geographic coordinates in the world coordinate system (e.g., the searched-for latitude and longitude of the electrical component). This transformation can be performed by an affine between the two coordinates.

U.S. patent application Ser. No. 14/304,545, the disclosure of which is hereby incorporated by reference in its entirety, serves as an example of a manner by which location information can be extracted to build electrical network maps (e.g., in a case where location is at least approximately known or anticipated); or for identification of object instances in a picture or arbitrary orientation with object classes for which models exist in the database. This can further refine the position given by the GPS information.

While exemplary embodiments have been shown and described in detail in the drawings and foregoing description, such description is to be considered illustrative or exemplary and not restrictive. Variations to the disclosed embodiments can be understood and effected by those skilled in the art and practising the claimed invention, from a study of the drawings, the disclosure, and the appended claims. In the claims, the word “comprising” does not exclude other elements or steps, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

Thus, it will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1. A method for providing cartographic information of an electrical component in a power network, wherein the cartographic information includes geographic coordinates and a type of the electrical component, the method comprising:
obtaining a visual representation of the electrical component, wherein the visual representation contains location information about where the visual representation was made;
determining the geographic coordinates of the electrical component based on the location information of the visual representation; and
identifying the type of the electrical component by matching the visual representation with predefined models relating to available kinds of electrical components.

2. The method according to claim 1, comprising:
providing a symbol indicative of the type of the electrical component into a map at a map location corresponding to the geographic coordinates of the electrical component.

3. The method according to claim 1, comprising:
obtaining the visual representation of the electrical component by an extraction from available visual material relating to the electrical component.

4. The method according to claim 1, comprising:
obtaining the visual representation by taking a picture or video with a camera.

5. The method according to claim 1, wherein the location information of the visual representation comprises GPS coordinates.

6. The method according to claim 1, wherein the location information of the visual representation comprises:
orientation information provided from a compass or a gyroscope.

7. The method according to claim 4, wherein the camera is a 3D camera which uses a stereo or time-of-flight principle.

8. The method according to claim 1, comprising:
calculating the geographic coordinates using image processing of the visual representation.

9. The method according to claim 2, wherein the location information of the visual representation comprises GPS coordinates.

10. The method according to claim 9, wherein the location information of the visual representation comprises:
orientation information provided from a compass or a gyroscope.

11. The method according to claim 10, comprising:
obtaining the visual representation by taking a picture or video with a camera.

12. The method according to claim 11, wherein the camera is a 3D camera which uses a stereo or time-of-flight principle.

13. The method according to claim 2, comprising:
calculating the geographic coordinates using image processing of the visual representation.

14. The method according to claim 3, comprising:
calculating the geographic coordinates using image processing of the visual representation.
